(19) United States
(12) Patent Application Publication
(10) Pub. No.: US 2010/0224047 A1
(43) Pub. Date: Sep. 9, 2010

(54) CHAINSAW

(76) Inventors: Karl Prodinger, Gfoehl (AT); Wolfgang Neumayer, Wien (AT); Ingo Freithofnigg, Loosdorf (AT)

Correspondence Address: KF ROSS PC, 5683 RIVERDALE AVENUE, SUITE 203 BOX 900, BRONX, NY, 10471-0900, US

(21) Appl. No.: 12/681,905

(22) PCT Filed: Oct. 25, 2008
(86) PCT No.: PCT/EP08/09048

§ 371 Date: Apr. 27, 2010

(30) Foreign Application Priority Data
Oct. 31, 2007 (AT) A 1762/2007

(51) Int. Cl. B27B 33/14; B23P 15/28

(52) U.S. Cl. 83/830; 76/112

(57) ABSTRACT

The invention relates to a chainsaw having chain links (1), such as chain links and connecting links, wherein the chain links (1) comprise rivet openings (2), in which pins (3) are disposed that form jointed connections between the chain links (1), and wherein at least one sealing means (4) is provided around each of the rivet openings (2) between the surfaces of the chain links (1) facing each other, and wherein the sealing means (4) is also directly connected on a chain link (1) and thus only one sealing surface is formed against the chain link positioned on the opposite side. The invention further relates to a method for the production of a chainsaw having the above mentioned chain links (1).

The invention relates to a chain-saw chain having links, such as saw links and connecting links, the links having rivet holes in which fit pins that form pivots between the links, and at least one seal around each rivet hole, between confronting faces of the links. The invention further relates to a method of making a saw chain.

Links are known that have a seal around each rivet hole, a seal ring inlaid in a groove being provided as seal. It is disadvantageous that two sealing surfaces are present between the seal ring and the two links. As a result, wear or soiling may occur on both sealing surfaces. In addition, assembly of the saw chain with mounting of the seal rings between the links is very complicated.

The object of the invention, therefore, is to provide a saw chain and a method of making same that eliminate the disadvantages described above.

For a saw chain according to the invention, this object is attained in that the seal is formed directly on only one of the links, so that only one sealing surface with respect to the other link of the pair is formed.

Directly forming the seal on the link allows the depth and width of the resulting seal to be easily varied, depending on the requirements, by changing the pressure, the quantity, and the composition of the material of the seal.

One feature of the invention is that at least the link on which the seal is formed has an annular groove around the rivet hole for receiving the seal.

As a further feature of the invention, the seal is a stellate ring having at least three points facing away from the rivet hole and engaged around the rivet hole. This design has the particular advantage that contaminants that collect between the points of the star are moved outward by the star points of the seal due to the motion of the two links relative to one another, and therefore are not able to advance inward to the rivet hole.

In a further alternative embodiment the seal may be flat and applied on the entire surface of the link.

As a further possible embodiment, the link around the rivet hole may have at least three protrusions in the form of bumps on the surface facing the other link of the pair. These bumps may be formed, for example, by embossing the link. They ensure a certain minimum spacing between the links, so that movement of the links relative to one another occurs by sliding over the bump heads, similar to a ball bearing. The seal, as described above, is situated either around the rivet in a groove, or flatly over the entire link, resulting in less wear on the seal on account of the bumps there.

In addition, a plurality of seals having different characteristics may be provided to improve the seal between the links. These seal may be configured, for example, in concentric rings around the rivet hole.

Furthermore, the object of the invention is attained using a method of making a saw chain, characterized in that the seal is applied to the link using a printing process, preferably a screen-printing process, and is thus formed on the link.

The screen printing technique allows between 100 and over 1000 links to be printed in a few seconds in a single operation. The classical screen printing technique itself is not very complicated, using a screen with the desired pattern as holes, and the application process. In this technique, an offset, the so-called “jump,” is necessary to prevent links from sticking to the screen after the printing operation. For this “jump” the screen should have a distance of 2-3 millimeters from the printed article after the printing operation.

Another variant of the screen printing operates from the start with a spacing of approximately one millimeter, since the seal must have a minimum thickness, and the printing is performed at this spacing. In this case uniform application is more difficult because the screen no longer functions as a flow limiter.

With regard to the surface of the seal, there are numerous variants of materials that may be used as seal:
Silicones that produce a smooth surface due to self-flow or under the influence of heat
Silicones in the form of a paste in which the mesh of the screen remains visible
Materials having low adhesive force during application; i.e. slight detachment from the screen
Materials having high adhesive force during application; i.e. good adhesion to the workpiece, but also to the screen
Materials that adhere only to the surface of the metal and that may be worn off
Materials that vulcanize with the surface and that may be removed only by intense mechanical machining.

For screen printing it may also be necessary to provide the links with their own matrix. This matrix should have the following prerequisite characteristics:
Exact positioning of the screen and links; guide pins accurate to within 1/10 mm
Retaining device for the links; for example, magnet, negative pressure, clamps
Provision of a spacer in the matrix
Alternatively, provision of a grid as spacer between the screen and the printed article
Resistance to heating/drying/setting processes using heat
Nonadherent covering of the printed article to achieve a uniform height of the seals.

Another approach would be to use a rotating screen that runs synchronously with the article to be printed and applies the compound during the motion.

A further alternative is a form of writing the seal onto the link, using an ink jet printer or a comparable print head.

Other printing methods are conceivable, for example a metering technique using a hollow needle. In the metering technique each link must be separately “written” with the seal, using the hollow needle controlled by a computer. Another possible alternative is the pad printing technique; this technique only represents an aid for receiving preprinted elements, in this case seals, on a soft rubber pad directly after production, and then depositing them on any given surface using light pressure.

A further feature of a method according to the invention for making a saw chain is that the seal is formed of two parts and is formed on the link by combining the two parts at the appropriate position on the link.

A further feature of the invention is that the seal is positioned on the link, and is formed on the link by vulcanization.

The seal may also be formed on the link by the action of temperature, for example heat or cold, or radiation, for example UV radiation.

Further features can be seen in the claims, drawings, and description:

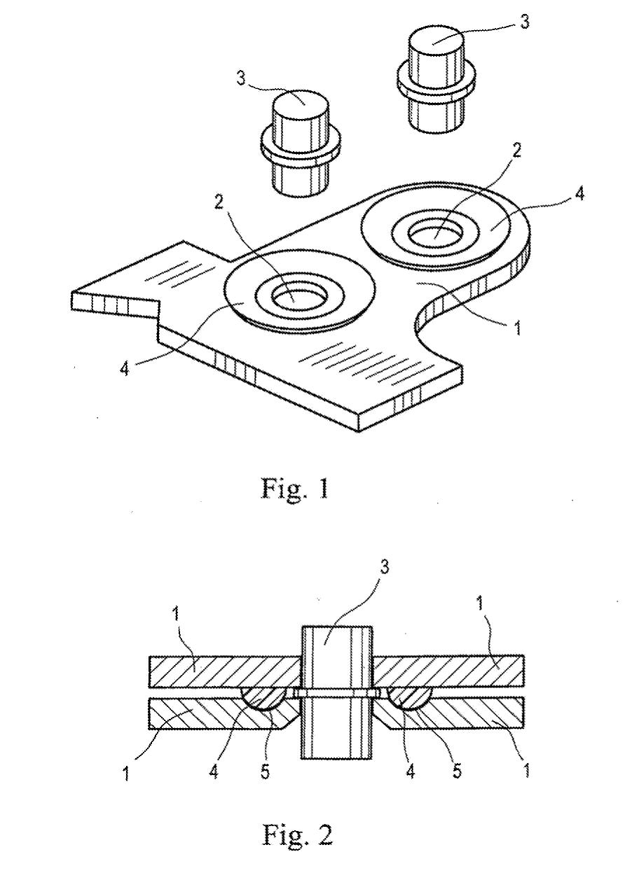

FIG. 1 is a perspective view of a link plate of a saw chain according to the invention.

FIG. 2 is a longitudinal section through of two adjacent links of a saw chain according to the invention.

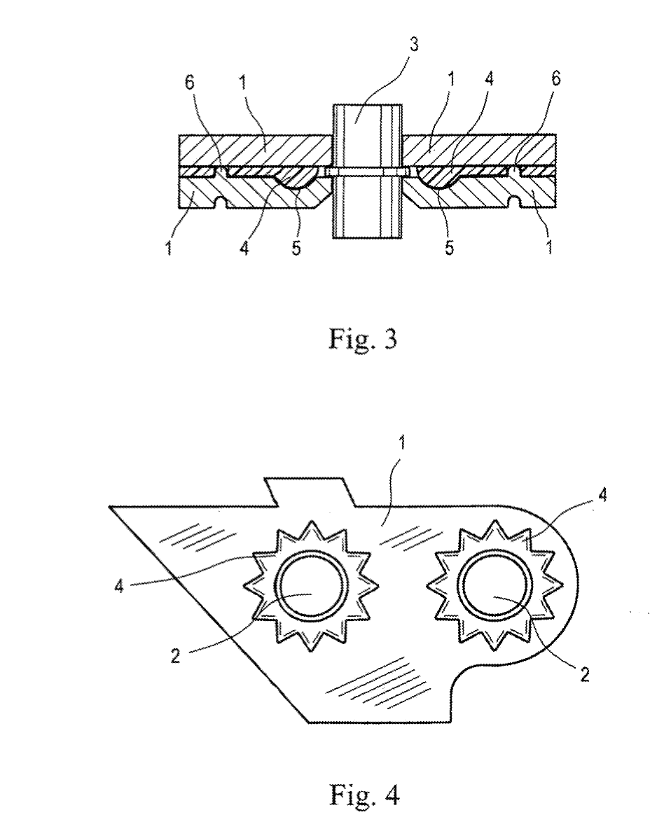

FIG. 3 is a longitudinal section of an alternative embodiment of two links of a saw chain according to the invention.

FIG. 4 is a view of a link plate in a further embodiment of a saw chain according to the invention.

The link plate 1 shown in FIG. 1 has rivet holes 2 by means of which the other chain links are pivoted via pins 3. An annular seal 4, which according to the invention is formed on the link 1, extends around the rivet hole 2.

Links for a saw chain have a specific distribution of forces. The pin in the rivet hole absorbs the tensile loads conducted from the links to the pins. This results in a considerable bending torque that is taken up by a short, compact, pin-like structure. Both links have rivet holes that are subjected to very high tensile stresses.

These forces resulting from tension are superimposed on additional forces caused by tilting of the chain under lateral load, and these additional forces must then be absorbed by the edge of the pin and the flanks of the link. The profile of the acting forces and the various loads must be taken into account when a seal is intended to perform its function over a long period of time.

To prevent the seal from being quickly worn down or damaged by the lateral forces, as shown in FIG. 2 a groove 5 is provided around the rivet hole in which the seal 4 fits. This mounting the seal produces an overall seal ring height of less than 0.4 mm. The projecting height of the seal is approximately 0.1-0.2 mm. The seal must fit into the groove under full load without damage to its material. This results in a groove depth of 0.3-0.4 mm. A greater depth provides more room for the absorption of compression, and results in a longer expected service life of the seal.

FIG. 3 shows an embodiment in which the seal 4 is applied over the entire surface of the link 1. In addition, impressed bumps 6 are formed next to the groove 5. During use of the saw chain the seal 4 in particular wears down quickly around the outer periphery of the link 1, resulting in contact between the bumps 6 and the other link of the pair 1. Motion of the two links relative to one another thus causes the link 1 to slide on the bumps 6, and the seal 4 around the rivet hole cannot be further damaged.

FIG. 4 shows a further embodiment of a link 1 having a seal 4 around the rivet hole 2, in this case the seal 4 being a stellate ring. Motion of the other link of the pairs relative to one another thus causes contaminants between the links to be conducted outward by the stellate projecting points of the seal 4.

1. A chain-saw chain having links, the links having rivet holes in which fit pins that form pivots between the links, and at least one seal around each rivet hole, between the confronting faces of the links, the seal being formed directly on a link so that only one sealing surface with respect to the other link of the pair is formed.

2. The saw chain according to claim 1, wherein at least the link on which the seal is formed has an annular groove around the rivet hole for receiving the seal.

3. The saw chain according to claim 1 wherein the seal is a stellate ring having at least three points facing away from the rivet hole is provided around the rivet hole.

4. The saw chain according to claim 1 wherein the seal fits flat on the entire surface of the link.

5. The saw chain according to claim 1 wherein the link around the rivet hole has at least three protrusions in the form of bumps on the surface facing the other link of the pair.

6. The saw chain according to claim 5, wherein the bumps are formed by embossing the link.

7. The saw chain according to claim 1 wherein a plurality of seals having different characteristics are provided.

8. The saw chain according to claim 7, wherein the seals are configured in concentric rings around the rivet hole.

9. A method of making a saw chain according to claim 1, wherein the seal is applied to the link by a printing process and is thus formed on the link.

10. A method of making a saw chain according to claim 1, wherein the seal is sprayed onto the link.

11. A method of making a saw chain according to claim 1, wherein the seal is formed of two parts and is formed on the link by combining the two parts at the appropriate position on the link.

12. A method of making a saw chain according to claim 1, wherein the seal is positioned on the link, and is formed on the link by vulcanization.

13. A method according to claim 1, wherein the seal is formed on the link by the action of temperature or radiation.

14. A chain-saw chain comprising:
a succession of links each formed by a pair of juxtaposed plates each formed with a pair of transversely throughgoing holes each aligned transversely with the holes of the other plate, the plates of each pair having confronting faces;
two respective pivot pins on each link each passing through the respective aligned holes, adjacent links of the succession of links being pivoted together at the pins; and
a respective seal adhered to the face of one of the plates of each of the pairs of plates around each of the respective holes and bearing transversely and slidable on the face of the other of the plates of the respective pair.

15. The chain-saw chain defined in claim 14 wherein the faces of the one plates are each formed around each of the respective holes with an annular groove open toward the other plate of the respective pair and receiving the respective seal.

16. The chain-saw chain defined in claim 15 wherein each groove is generally of semicircular cross section and the seals fit complementarily to the respective grooves.

17. The chain-saw chain defined in claim 16 wherein each seal has a planar outer face sliding on the face of the other respective plate.

18. The chain-saw chain defined in claim 14 wherein the seal is flat.

19. The chain-saw chain defined in claim 18 wherein the face of the one plate of each pair is formed with round-top bumps projecting toward the other plate of the pair and projecting generally through the respective flat seal.

20. The chain-saw chain defined in claim 14 wherein each pin is substantially cylindrical, centered on a respective axis, and formed with a radially projecting spacer flange engageable with the faces of the plates of the respective pair.
